(19) United States
(12) Patent Application Publication
(10) Pub. No.: US 2007/0098358 A1
(43) Pub. Date: May 3, 2007

(54) Digital video recorder with jump-pause function

(75) Inventor: Kevin G. Mackenzie, Cornelius, OR (US)

Correspondence Address: Richard Calderwood;Stexar Corp., 20400 NW Amberwood Dr. #100, Beaverton, OR, 97006-7099, US

(73) Assignee: Stexar Corporation

(21) Appl. No.: 11/261,827

(22) Filed: Oct. 28, 2005

(51) Int. Cl. H04N 5/91

(52) U.S. Cl. 386/68

(57) ABSTRACT

A television set, digital video recorder, or the like having a user-operable jump-to-start-and-pause function. When activated, such as via a remote control unit button or an on-screen menu item, the jump-to-start-and-pause function jumps or rewinds the currently playing video program to its beginning and pauses until the user e.g. selects a play function.

### BACKGROUND OF THE INVENTION

1. Technical Field of the Invention

This invention relates generally to digital video recorders (DVRs), and more specifically to fast-forward and rewind functionality of DVRs.

2. Background Art

FIG. 1 illustrates a conventional television set. The television set includes a display panel, illustrated as displaying a scene from a water ski program called “The Brad Show”. The television set includes panel driver electronics which provide a video output signal to the display panel. A tuner is coupled to receive a video input signal from at least one input connector which is connected to e.g. a cable television system, a satellite television receiver, a terrestrial broadcast reception antenna, or what have you. Logic such as a programmable microprocessor or digital signal processor, or hard-wired logic such as an ASIC, provides control logic functionality of the television set, and is coupled to a memory which holds data and instructions. The television set typically includes user operable buttons such as a power button, volume up and down buttons, channel up and down buttons, and the like. The television set typically also includes a wireless receiver for receiving signals from a remote control unit.

The remote control unit includes a wireless transmitter for sending the signals to the television set. Logic, whether programmable or hard-wired, provides functionality of the remote control, typically as defined by data and instructions stored in a memory. A battery provides electric power for the remote control unit.

The remote control unit includes a plurality of user operable buttons which control various aspects of the television set's operation. For example, the remote control unit may include a power button for turning the television set on and off, volume up and down, channel up and down, channel number digit buttons, and so forth.

In the case of a television set which includes a video recording mechanism (whether built into the television set itself, as shown, or built as a separate component coupled to the television set), the remote control unit will also include a plurality of buttons for controlling playback and recording of programs. Standard buttons and their corresponding functionality, which are generally present in nearly all such remote control units, include:

| | |
|---|---|
| play = | [symbol] |
| stop = | ▪ |
| fast-forward = | [symbol] |
| rewind = | [symbol] |
| record = | ● |
| pause = | [symbol] |
| jump-to-start = | [symbol] |
| jump-to-end = | [symbol] |

These buttons can be used to control playback of video from a variety of local sources, including e.g. a built-in DVR, a stand-alone DVR, a video cassette recorder (VCR), or from a remote source such as a video-on-demand system located at the cable head end. These will generically be referred to as “recorded video sources”.

When the user presses the jump-to-start button, the recorded video source jumps (or rewinds, in the case of a VCR) to the beginning of the program and immediately re-starts playback of the program.

However, the user may often want to jump to the start of the program and not begin playback. For example, if he turns on the television half-way through an in-progress recording which he wants to watch in its entirety, he may want to jump back to the start and then wait, while he procures a sandwich and a cold lemonade, before settling down to watch the program.

With present systems, this requires the user to press the [symbol] jump-to-start button, wait for the program to actually jump to the beginning of the program, then press the [symbol] pause button. This may be inconvenient for the user, especially but not only in the case of a VCR or other non-randomly-accessed video source which takes a significant amount of time to rewind or the like.

What is desirable, then, is an improved ability to control a recorded video source, enabling jump-to-start and pause functionality with a minimum of user effort.

### BRIEF DESCRIPTION OF THE DRAWINGS

FIG. 1 shows a conventional television set and a remote control unit for controlling its operation.

FIG. 2 shows the television set part-way through playback of a program.

FIG. 3 shows the television set after actuation of the jump-to-start-and-pause functionality of the present invention.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

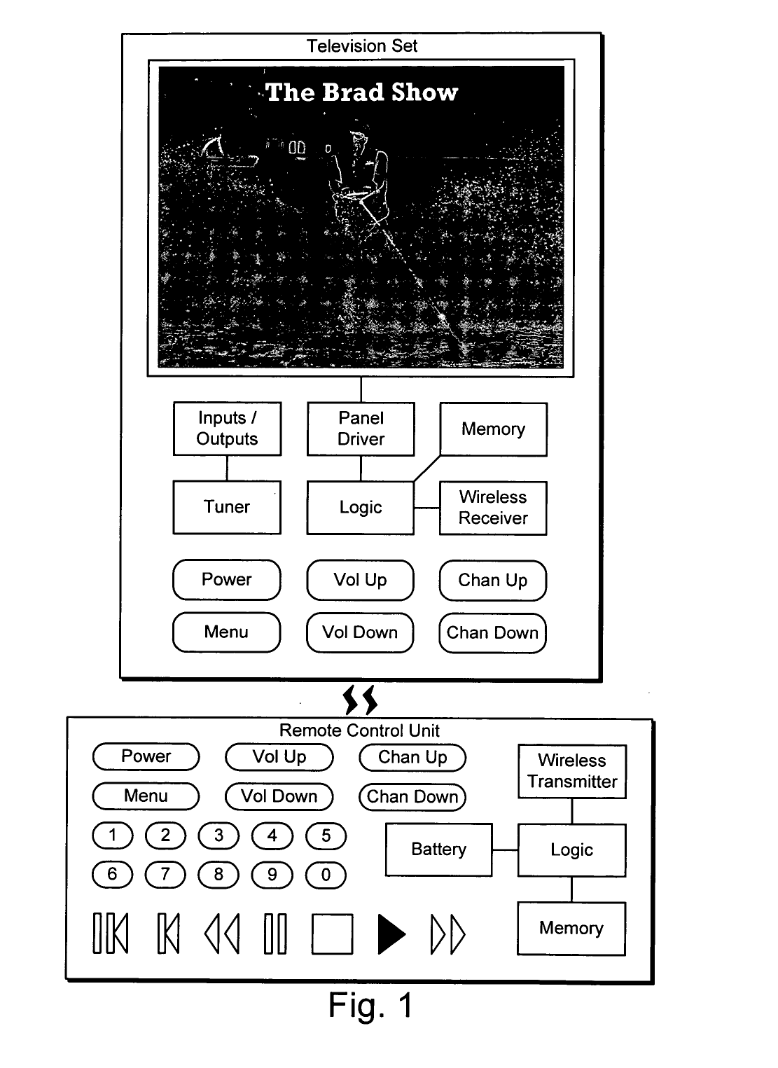

FIG. 1 illustrates the television set as displaying the opening scene of a water skiing program. The title “The Brad Show” is shown for purposes of suggesting that the program is at its beginning, when titles are commonly displayed.

The [symbol] play button on the remote control unit is highlighted, suggesting that the user has pressed that button to begin playback of the program from its recorded video source.

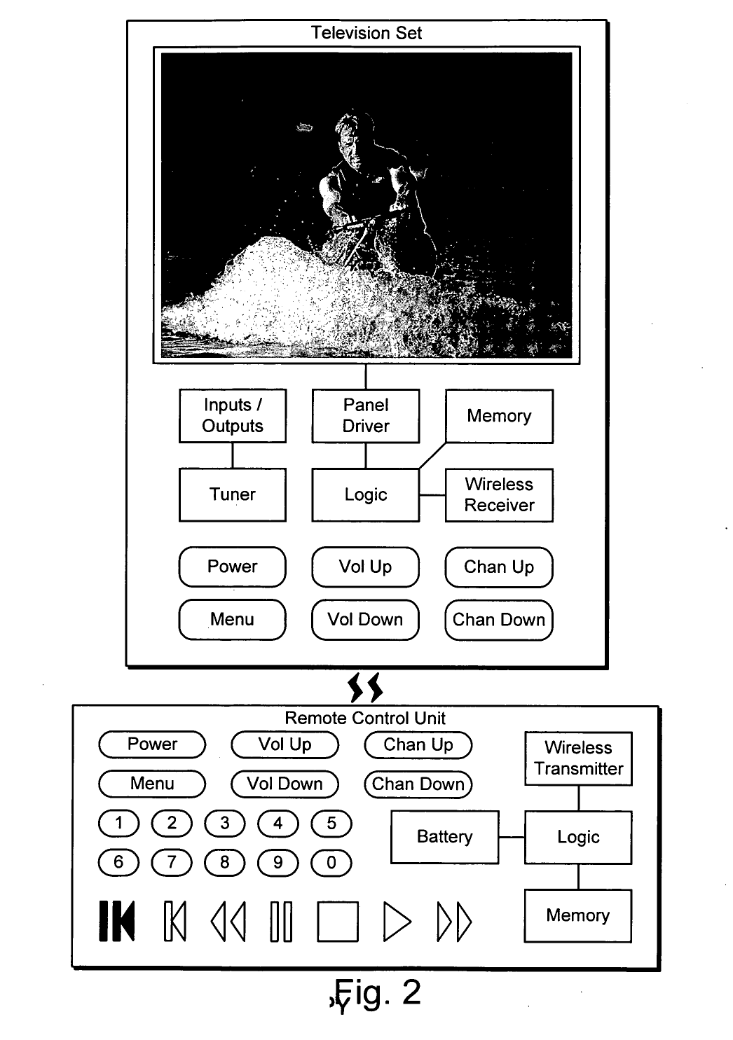

FIG. 2 illustrates the television set as displaying a later scene in the water skiing program.

According to one embodiment of this invention, the remote control unit is enhanced with an additional jump-to-start-and-pause button, highlighted in black to suggest that the user has just activated that button. In one such embodiment, the button is formed as the conventional pause symbol [symbol] juxtaposed with a single left arrow [symbol] . In another embodiment, it is formed as the conventional pause symbol [symbol] juxtaposed with a double left arrow [symbol] .

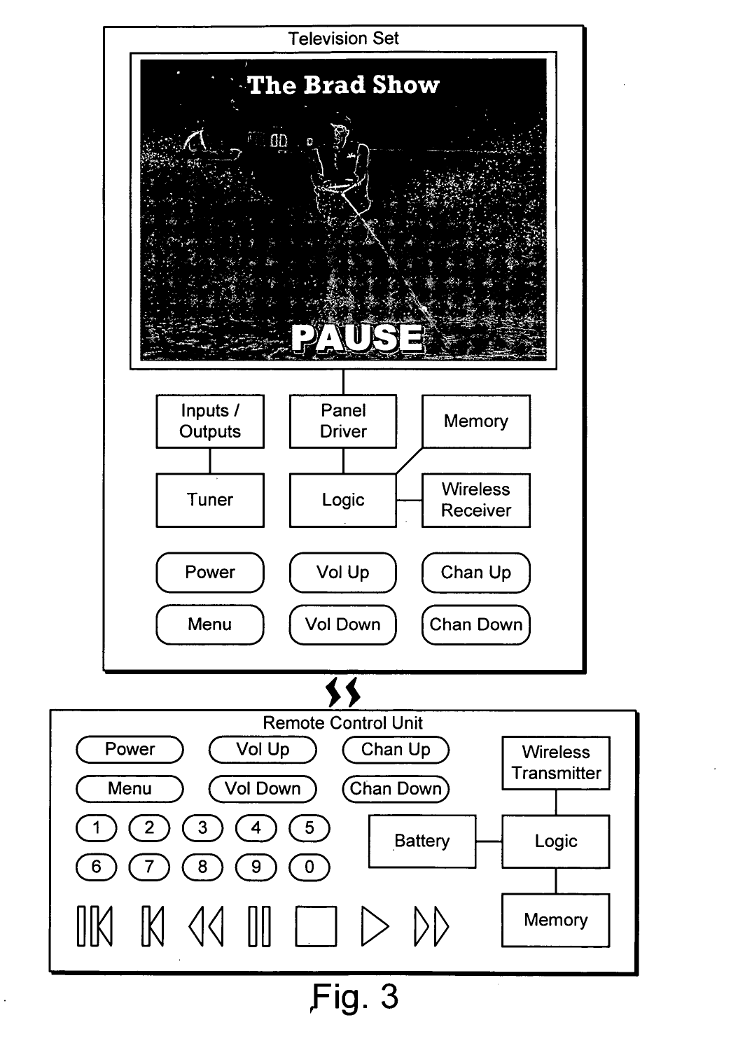

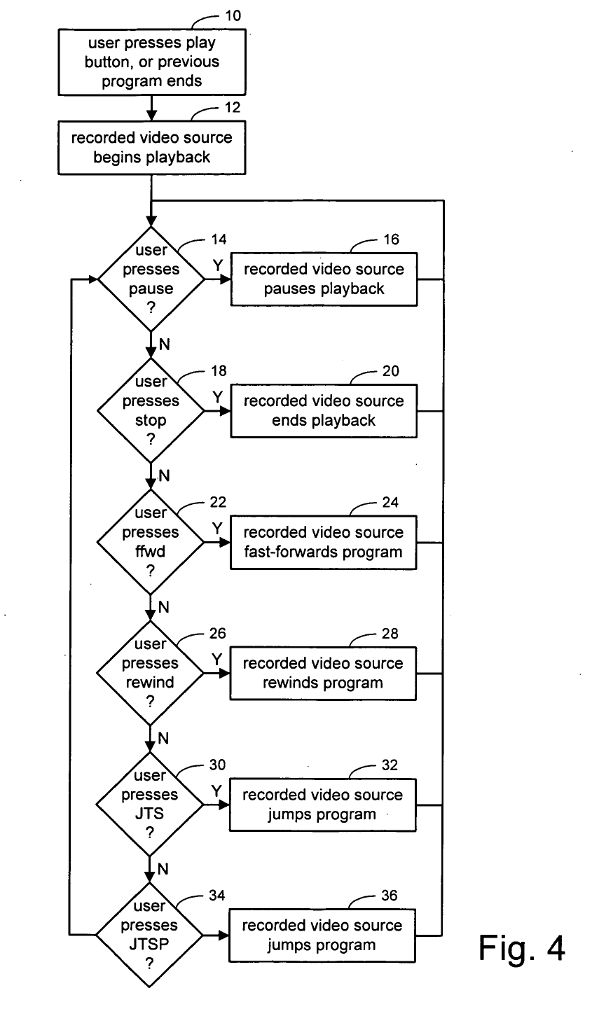

FIG. 3 illustrates the television set as displaying a still frame from the opening scene, with the video playback paused. In one embodiment, a visual cue such as the word “pause” is overlayed on the display, to remind the user why the video is not playing in motion.

When the user then presses the [symbol] play button, the video program will begin playing and the visual “pause” cue will be removed from the display.

In one embodiment, the visual cue is added as an overlay by the television set's menuing system. In another embodiment, the visual cue is added by the television set's on-screen programming guide system (not shown).

FIG. 4 illustrates one method of operation of the television set, remote control unit, and/or recorded video source according to this invention. The method may begin when the user presses (10) the play button, or when a prior program ends and a new program begins. Then, the recorded video source begins (12) playback of the current video program. If (14) the user presses the pause button, the recorded video source pauses (16) playback of the current program. If (18) the user presses the stop button, the recorded video source ends (20) playback of the current program. If (22) the user presses the fast-forward (ffwd) button, the recorded video source fast-forwards (24) playback of the current program. If (26) the user presses the rewind button, the recorded video source rewinds (28) playback of the current program. If (30) the user presses the jump-to-start (JTS) button, the recorded video source jumps (32) playback to the beginning of the current program. If (34) the user presses the jump-to-start-and-pause (JTSP) button, the recorded video source jumps (36) playback to the start of the current program and more or less immediately pauses playback. If the user does not press a button, playback simply continues.

The flowchart should not be interpreted as a robust, complete state diagram, as it is not intended to be such.

### CONCLUSION

When one component is said to be adjacent to or coupled to another component, it should not be interpreted to mean that there is absolutely nothing between the two components, only that they are in the order indicated and that they are somehow connected.

The various features illustrated in the figures may be combined in many ways, and should not be interpreted as though limited to the specific embodiments in which they were explained and shown.

Although the invention has, for convenience, been illustrated in the drawings as embodied in a television set having a built-in PVR functionality, the reader should appreciate that it may just as readily be practiced in a stand-alone PVR, or in a video-on-demand playback system, or in a VCR, and so forth.

The jump-back-and-pause feature may be activated via a dedicated button on the television set, PVR, remote control unit, or the like. Or, it may be activated via an on-screen menu.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of operating a recorded video source, the method comprising the recorded video source:
playing a video program;
receiving from a user a jump-to-start-and-pause control input; and
responsive to receiving the jump-to-start-and-pause control input,
returning playback of the video program substantially to a start of the video program, and
pausing playback of the video program substantially at the start of the video program.

2. The method of claim 1 wherein:
returning comprises jumping.

3. The method of claim 1 wherein:
returning comprises rewinding.

4. The method of claim 1 further comprising:
the user pressing a jump-to-start-and-pause button of a remote control unit; and
the remote control unit transmitting a jump-to-start-and-pause signal to the recorded video source, which receives the signal as the jump-to-start-and-pause control input.

5. The method of claim 1 wherein:
the recorded video source comprises a digital video recorder.

6. The method of claim 1 wherein:
the digital video recorder is built into a television set.

7. A method whereby a user controls playback of a video program on a television set, the method comprising:
the television set displaying the video program;
during display of the video program, the user activating a jump-to-start-and-pause control;
in response to the activation of the jump-to-start-and-pause control, playback of the video program returning substantially to a start of the video program and pausing substantially at the start of the video program.

8. The method of claim 7 further comprising:
the jump-to-start-and-pause control comprising a button of a remote control unit;
the remote control unit wirelessly communicating a signal indicating that the button has been activated;
a source of the video program responding to the signal to return playback substantially to the start and pausing.

9. A recorded video source comprising:
means for storing a recorded video program;
means for playback of the recorded video program; and
means, responsive to a user control request, for returning playback substantially to a beginning of the recorded video program and for then pausing playback substantially at the beginning.

10. The recorded video source of claim 9 further comprising:
a remote control unit for wirelessly communicating the user control request to the recorded video source.

11. The recorded video source of claim 10 further comprising:
a video display panel for displaying the recorded video program.

12. The recorded video source of claim 11 wherein:
the video display panel, the means for storing, and the means for playback comprise a television set.

13. The recorded video source of claim 11 wherein:
the means for storing and the means for playback comprise a digital video recorder; and
the video display panel comprises a television set coupled to the digital video recorder.

14. A television set comprising:
a video display panel for displaying a video program;
a built-in digital video recorder coupled to the video display panel for recording video programs;
control means, coupled to the digital video recorder, for controlling playback of the recorded video programs, the control means including,
means responsive to a user control input for jumping a current video program substantially to its beginning and for then pausing playback of the current video program substantially at the beginning.

15. The television set of claim 14 further comprising:
a wireless remote control unit having a jump-to-start-and-pause button which, when activated by a user, sends the user control input as a wireless signal to the control means.
